(19) United States
(12) Patent Application Publication
(10) Pub. No.: US 2003/0072329 A1
(43) Pub. Date: Apr. 17, 2003

(54) Segmentation of data transmission units into fixed size segments

(76) Inventors: Mark William Janoska, Carleton Place (CA); Henry Chow, Kanata (CA)

Correspondence Address: Shapiro Cohen, P.O. Box 3440, Station D, Ottawa, ON, K1P 6P1, CA

(21) Appl. No.: 09/969,598

(22) Filed: Oct. 4, 2001

Related U.S. Application Data
(60) Provisional application No. 60/240,842, filed on Oct. 17, 2000.

(51) Int. Cl. H04J 3/00

(52) U.S. Cl. 370/476; 370/474

(57) ABSTRACT

Methods and devices for dividing differently sized data transmission units into fixed sized segments for use with a switch core. Differently sized data transmission units are divided into a number of fixed size segments. Each of the fixed size segments has a segment header section and segment payload section. The segment header section has routing information for the segments and a field for indicating whether the segment payload section is fully occupied or not. The segment payload section carries the actual data from the data transmission unit that has been divided. If the segment payload section is not fully occupied, a field in the payload section indicates how much of the space in the segment payload section is occupied. To track segments from the same data transmission unit the segment header section also has a EOP or end of package field that indicates whether a segment the end of the sequence of segments derived from a single divided data transmission unit.

This application relates to U.S. Provisional Patent Application No. 60/240,842 filed Oct. 17, 2000.

### FIELD OF INVENTION

This invention relates to data communications networks, and more specifically, to methods and devices for segmentation and reassembly of data transmission units into segments that have a predetermined fixed size.

### BACKGROUND TO THE INVENTION

The development of high speed data communication networks has led to the need for developing high capacity high speed switches for routing data traffic from one point to another. Such high capacity high speed switches rely on switch cores that can effectively route incoming traffic from one of multiple input ports to one of multiple output ports. To do this effectively, it has been found that routing segments that have a predetermined fixed size is more efficient and thereby more desirable than routing segments that have different sizes. However, many popular external interfaces transmit and receive variable sized frames or data transmission units. Some examples of this are frame relay, MPLS (Multi-packet Label Switching), IP, and Ethernet and all of its variants. Clearly, a mechanism that divides these differently sized data transmission units into segments that have a fixed predetermined size is required if such high speed switch cores are to be used. Such a mechanism would receive differently sized data transmission units and divide them into fixed size segments prior to transmitting these fixed-size segments to a switch core. The switch core would then route these fixed size segments to the proper output port. Once these segments reach the output port and exit the switch core, these segments would then have to be reassembled to arrive at the original differently sized data transmission units for eventual transmission to the next network node.

Any such process that segments the incoming differently sized data transmission units must account for the probability that the data transmission unit can be any number of bytes in size and is, generally, not amenable to being divided into a whole number of fixed sized segments. Also, provision must be made in the resulting fixed size segments so that these can be properly routed through the switch core. An addressing function must therefore be part of any process that produces these fixed size segments. Furthermore, such a segmentation process should also account for the reassembly of the fixed size segments into their proper differently sized data transmitted units after the segments have transited through the switch core. Such an eventuality requires that there must be an indication within the resulting fixed size segments that determines to which data transmission unit the segment belongs to. It must be noted that in this context the term size is to be understood to mean the amount of data, usually measured in bytes, that a data transmission unit contains. It should also be understood that the term data transmission unit encompasses all types of units which are used to encapsulate data for transmission. This may therefore encompass packets or any other data encapsulation units regardless of the protocol or standard used.

Based on the above, there is therefore a need for a segmentation process that meets the above needs and that can be readily implemented for use with current switch cores.

### SUMMARY OF THE INVENTION

The present invention meets the above need by providing methods and devices for dividing differently sized data transmission units into fixed sized segments for use with a switch core. Differently sized data transmission units are divided into a number of fixed size segments. Each of the fixed size segments has a segment header section and segment payload section. The segment header section has routing information for the segments and a field for indicating whether the segment payload section is fully occupied or not. The segment payload section carries the actual data from the data transmission unit that has been divided. If the segment payload section is not fully occupied, a field in the payload section indicates how much of the space in the segment payload section is occupied. To track segments from the same data transmission unit the segment header section also has a EOP or end of package field that indicates whether a segment is the end of the sequence of segments derived from a single divided data transmission unit.

In a first aspect the present invention provides a method of dividing a data transmission unit (DTU) of unknown size into segments each having a fixed predetermined size, the method comprising:

a) receiving the DTU at an input port;

b) determining a connection identifier for the DTU;

c) determining a size of the DTU;

d) dividing the DTU into portions, each portion having a size not exceeding a predetermined portion size;

e) storing each of the portions in a segment, the segment having a fixed predetermined size;

f) storing the connection identifier in a connection identifier field in each segment;

g) setting a full field in each segment which has a payload section that is fully occupied by a portion from the DTU; and

h) setting an end of package (EOP) field in a last segment containing the last portion of the DTU.

In a second aspect the present invention provides a data segment having a fixed predetermined size, the segment being for storing and transmitting portions of a data transmission unit between a source and a destination the segment comprising:

a header section containing:

a destination field for storing a destination address for the segment;

a connection identifier for storing a connection identifier which identifies a parent data transmission unit;

a full field for indicating if a full condition is met;

an end of package (EOP) field for indicating if the segment is a last segment in a sequence of segments occupied by portions from the parent data transmission unit; and

a payload section containing a payload portion which stores a portion of data from the parent data transmission unit,

wherein the full condition is met if the payload section is completely occupied by the payload portion and the payload portion is completely occupied by the portion of data from the parent data transmission unit.

### BRIEF DESCRIPTION TO THE DRAWINGS

A better understanding of the invention will be obtained by a consideration of the detailed description below, in conjunction with the following drawings, in which:

FIG. 1 is a block diagram of a system for routing data traffic through a switch core;

FIG. 2 illustrates a format for a fixed size segment;

FIG. 3 is schematic diagram of how a differently sized data transmission unit can be divided into fixed size segment; and

FIG. 4 is a flow chart detailing the steps in processing a data transmission unit to result in fixed size segments.

### DETAILED DESCRIPTION

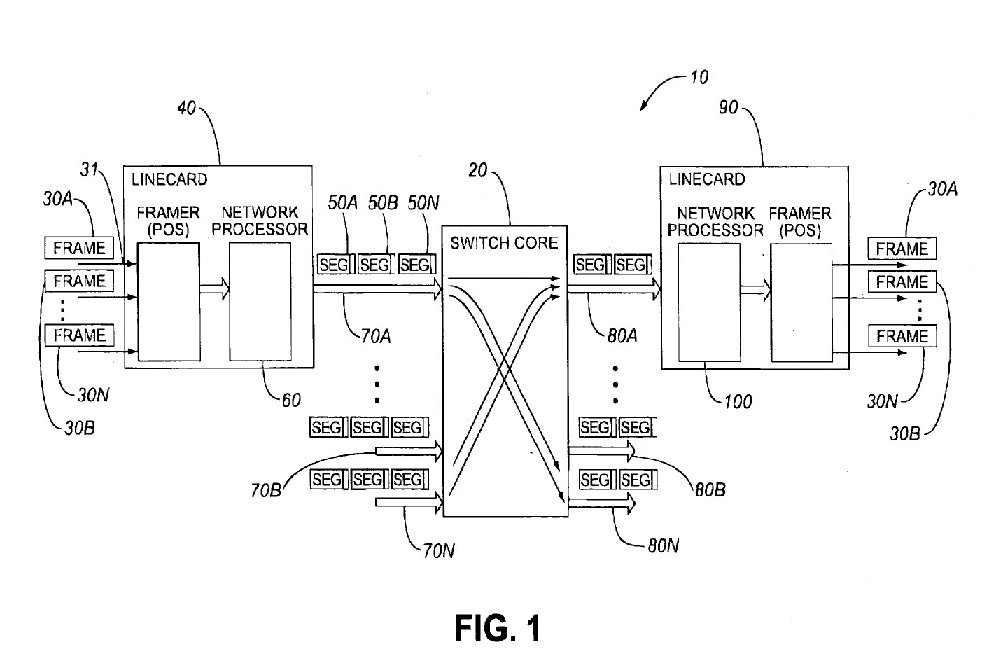

Referring first to FIG. 1, a block diagram of a system 10 for routing data traffic through a switch core 20 is illustrated. As can be seen from FIG. 1, data transmission units (DTU) 30A, 30B . . . 30n, arrive at an input port 31 of an input section 40 of the system 10. Input section 40 then divides each of the incoming data transmission units into fixed size segments 50A, 50B . . . 50n. This segmentation is carried out by a network processor 60 residing within the input section 40. The fixed size segments 50A . . . 50n are then transmitted in sequence into an input port of the switch core 20. Once the fixed size segments 50A . . . 50n arrive at the switch core 20 these segments are then routed to at least one output port of the switch core 20. The input ports 70A . . . 70n of the switch port 20 receives the fixed size segments 50A . . . 50n and the switch core 20 routes these segments to the appropriate output ports 80A . . . 80n of the switch core 20. Once the fixed size segments have exited from the switch core, they are received by an output section 90. The output section 90 receives the fixed size segments and, using a processor 100 residing within the output section 90, the fixed size segments are reassembled into their original differently sized data transmission units. These differently sized data transmission units are then transmitted to the output port (not shown) of the output section 90 in their original format as differently sized data transmission units 30A . . . 30n.

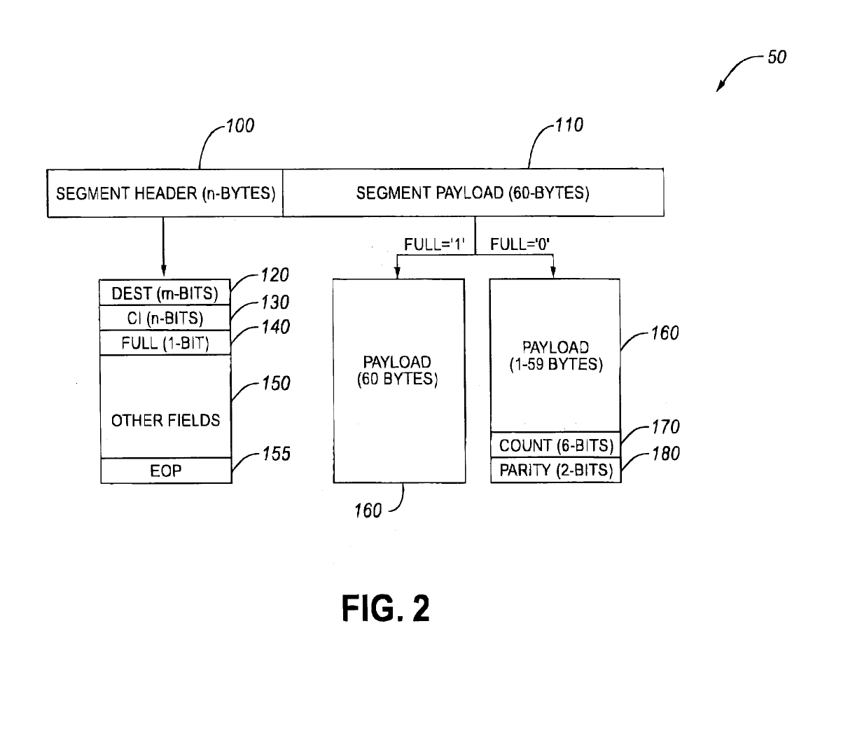

Referring now to FIG. 2, a format for a fixed sized segment 50 is illustrated. The segment 50 has a header section 100 and a payload section 110. The header section 100 has a destination field 120, a connection identifier field 130, a FULL field 140, and miscellaneous other fields 150. Also included in the header section is an EOP (end of package) field 155. The payload section 110 has a payload portion 160 and, optionally, may also have a count field 170 and a parity field 180.

The header section 100 has the fields that indicate to where the segment 50 is to be routed and to which data transmission unit (DTU) the segment belongs. The destination field 120 will contain an indication denoting which output port of the switch core is the destination of the segment 50. The entry in this field will be used by the switch core to route the segment 50 from a specific input port in the switch core to at least one specific output port of the switch core. The connection identifier field 130 identifies which connection the segment 50 belongs. The connection to which the segment 50 belongs also identifies the data transmission unit to which the segment 50 is a part of. The concept of the connection identifier field identifying the data transmission unit to which the segment belongs is effective because only one data transmission unit per connection is processed at a time. Thus, what occurs is a virtual pipelining of the data transmission units from a specific connection. Therefore, if a segment 50 is received by the output portion of the system 10, by checking the connection identifier and identifying which connection the segment belongs, the only conclusion is that the segment 50 that has arrived belongs to the data transmission unit that is currently being processed and not to a data transmission unit that is about to be processed.

Returning to the header section 100 of the segment 50, the full field 140 indicates whether the segment 50 has a full payload whether the payload section is completely used up by data from a data transmission unit or whether the payload portion of the payload section is only partially filled by this data. The inference that can be drawn from the full field 140 is that, if the full field is set, meaning that the payload section is completely filled up with data from a data transmission unit, then the count field 170 and the parity field 180 does not exist within that specific payload section.

The converse of the above then is that, if the full field 140 is not set, meaning that the payload portion 160 occupies less than the full payload section 110, then the count field 170 and the parity field 180 do exist and are used. The miscellaneous other fields 150 in the header section are left for use by the user or the system designer in case he or she wishes to insert any other control information in the header section 100.

The EOP or end of package field 155 indicates whether the segment to which the header section 100 is attached is the final segment in a sequence of segments belonging to a single data transmission unit. Once the output section of the system 10 encounters an EOP field 155 that is set, meaning that the segment to which the EOP field is attached is the final segment in a sequence of segments for a single data transmission unit, then the output section will know that the end of a data transmission unit has been found and that the next incoming segment is for another data transmission unit.

The payload section 110 of the segment 50 can be fully occupied by data from a single data transmission unit or it can be partially occupied by data from a data transmission unit along with a count field 170 and a parity field 180. If the payload section 110 is fully occupied by data from a data transmission unit, then, as noted above, the full field 140 will be set. However, if the payload section 110 is not completely filled by the data from the data transmission unit then the count field will indicate how much of the payload section 110 is occupied by the payload portion 160 which contains the actual data from the data transmission unit. If the count field is present then the parity field 180 is also present as this parity field 180 provides an error correction function for the count field 170. By checking the parity field 180 one can therefore test to see if the integrity of the data in the count field 170 has been compromised or not. This function is fairly important given that if the count field 170 indicates 30 bytes in payload portion 160 then only the first 30 bytes of the of the payload portion 160 are valid. If, however, the count field 170 has been corrupted and now indicates 40 bytes instead of the correct 30 bytes then the data transmission unit that results after the reassembly of all the segments in the sequence will have corrupt data and may therefore be useless. It should be noted that the location of the count field 170 and the parity field 180 need not be at the end of the payload section 110 as shown in FIG. 2. In fact, the count field 170 and the parity field 180 can be anywhere within the payload section 110. Ideally, however, the count field 170 and the parity field 180 should be located at either the front or the top of the payload section 110, or at the bottom or tail end of the payload section 110. This is due to the fact that if these fields were at the front or the back of the payload section 110, then they would be easier to locate.

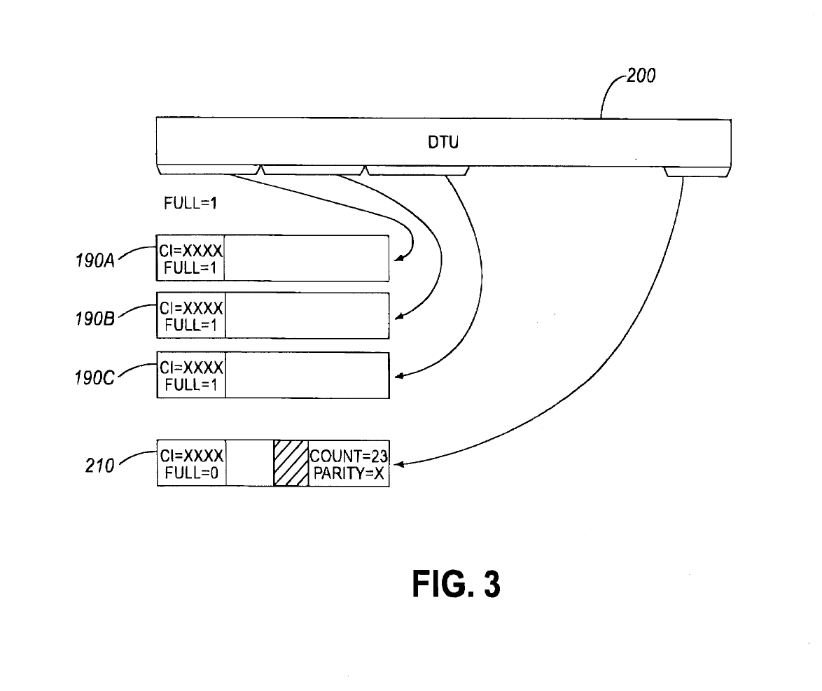

Referring now to FIG. 3, a schematic diagram of how a differently sized data transmission unit can be divided into a number of fixed size segments is illustrated. The variable length data transmission unit, once received by the input portion of the section 10 is first processed by the input section 40 to determine any control information within the data transmission unit. This control information can range from the destination of the DTU to the connection identifier for the DTU and can include the size of the DTU. Given that the fixed size of the segments is predetermined and given the size of the DTU, the input section 40 of the system 10 can therefore determine how many fixed size segments will be required to completely encapsulate the data contained in the data transmission unit. This can be determined by merely dividing the size of the data transmission unit by the predetermined size of the segments. The result of this operation will indicate how many segments are required and how much of the data transmission unit will have to partially fill a segment. As an example, if a data transmission unit had a size of 192 bytes and if the predetermined fixed size for each segment is given as 60 bytes, then it should be clear that three completely filled segments will be generated and a fourth partially full segment having 12 bytes as its payload will complete the segmentation of the data transmission unit. As can be seen in FIG. 3, the completely filled segments 190A, 190B, 190C are generated from a differently sized data transmission unit 200 while a partially full segment 210 results from the last few bytes of the DTU 200.

It should be noted that the EOP field 155 for completely filled segments 190A, 190B, 190C are not to be set as none of these segments is the final segment derived from the DTU 200. However, partially full segment 210 is the final segment to be derived from the DTU 200 and, because of this, the EOP filed 155 for this segment 210 must be set.

It should also be noted that, as shown in FIG. 3, the count field and the parity field exist in the partially filled segment 210 as the payload portion of that segment does not completely fill the payload section of the segment. Furthermore, as shown in FIG. 3, the full field in partially filled segment 210 is not set while the full field for the full segments 190A, 190B, 190C are set. As noted above, this indicates that for the segments 190A, 190B, 190C, the payload section for these segments are completely occupied by data from the data transmission unit 200. Conversely, since the payload section 110 for the segment 210 is not completely occupied by data from the DTU 200, then the full field for this segment is not set.

The value to be stored in the connection identifier field of each segment generated from a data transmission unit is derived from the header of the data transmission unit. The header of the data transmission unit will indicate the connection to which the data transmission unit belongs and, based on this, a connection identifier can be formulated. Once the connection identifier is formulated it can therefore be placed in the connection identifier field 130 for each segment generated from the DTU.

The destination identifier to be stored in the destination field can also be derived from the header of the DTU. Since the DTU header will contain the end destination of the DTU, this can be used to formulate the destination identifier. The destination identifier can relate to the output port in the switch core so that the segments deriving from the DTU can properly routed to that output port. For example, if a DTU is to be routed from node A to node Z then there must be a specific output port in the switch core that provides a route from node A to node Z. This particular DTU, when received by the input portion of the system 10, will therefore be processed by the input portion to retrieve the header data from the DTU so that a destination identifier may be formulated. If, for example, output port Q1 is the relevant output port leading to node Z through the switch core, then the destination identifier field for segments derived from the arriving DTU will have the value Q1 inserted into the destination identifier field 130. Any segments derived from the arriving DTU will therefore have Q1 in their destination identifier field. Once the segments from this DTU are transmitted through the switch core, the switch core will send these segments to output port Q1. The segments will then be received by the output portion of the system after passing through the output port Q1. The output portion will then reassemble the segments received in sequence to arrive at the original DTU. This reassembled DTU can therefore be routed from the output portion of the system to node Z.

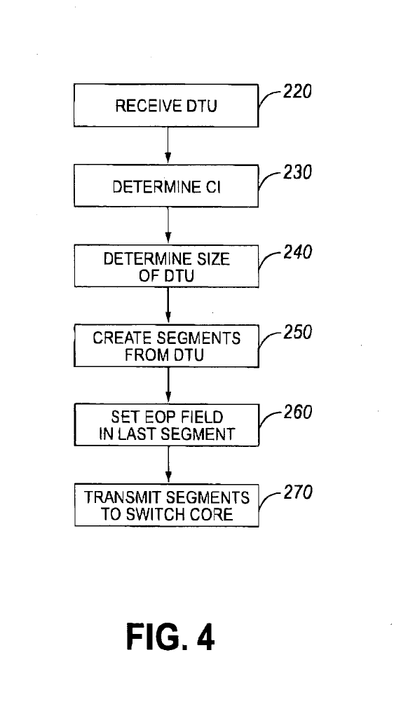

To summarize the processing that a data transmission unit receives once it is received at an input portion of a system using a switch core, FIG. 4 is a flow chart detailing the steps in this process. The process begins with step 220, that of the DTU being received by the input portion of the system. Step 230 is that of determining the connection identifier of the specific DTU based on the header data from the DTU. Once the connection identifier has been determined, step 240 is that of determining the size of the received DTU. This step can be accomplished by either checking the header of the DTU or by other suitable means. By determining the size of the DTU, a clear indication as to how many segments will be needed is found. Step 250 is that of actually creating the segments from the DTU by dividing the DTU into fixed size portions with each portion being stored in a payload section of a segment. Each segment derived from the DTU will have its header fields properly set. This includes the setting the full field for the segments that are completely occupied by data from the DTU and properly setting the connection identifier field and a destination identifier field. Once all the segments are created, an important step is that of steps 260, setting the EOP or end of package field in the last segment generated for the DTU. As noted above, this is fairly important as the end of package field determines when a DTU has ended and when a new DTU is about to begin. With all the segments properly created these segment can therefore be transmitted to the switch core for routing to the output portion of the system (step 270).

We claim:

1. A method of dividing a data transmission unit (DTU) of unknown size into segments each having a fixed predetermined size, the method comprising:
a) receiving the DTU at an input port;
b) determining a connection identifier for the DTU;
c) determining a size of the DTU;
d) dividing the DTU into portions, each portion having a size not exceeding a predetermined portion size;
e) storing each of the portions in a segment, the segment having a fixed predetermined size;
f) storing the connection identifier in a connection identifier field in each segment;
g) setting a full field in each segment which has a payload section that is fully occupied by a portion from the DTU; and
h) setting an end of package (EOP) field in a last segment containing the last portion of the DTU.

2. A data segment having a fixed predetermined size, the segment being for storing and transmitting portions of a data transmission unit between a source and a destination the segment comprising:
a header section containing:
a destination field for storing a destination address for the segment;
a connection identifier for storing a connection identifier which identifies a parent data transmission unit;
a full field for indicating if a full condition is met; and
an end of package (EOP) field for indicating if the segment is a last segment in a sequence of segments occupied by portions from the parent data transmission unit,
a payload section containing a payload portion which stores a portion of data from the parent data transmission unit,
wherein the full condition is met if the payload section is completely occupied by the payload portion and the payload portion is completely occupied by the portion of data from the parent data transmission unit.

3. A data segment as in claim 2 wherein the payload section further includes a count field for storing an indication of how much of the payload portion is occupied by the portion of data from the parent data transmission unit.

4. A data segment as in claim 3 wherein the payload section further includes a parity field for determining if data stored in the count field is corrupted.

5. A data segment as in claim 2 wherein the full field is a 1-bit field.

6. A data segment as in claim 2 wherein the EOP field is a 1-bit field.
